(19) United States
(12) Patent Application Publication
(10) Pub. No.: US 2012/0019391 A1
(43) Pub. Date: Jan. 26, 2012

(54) Power Indicator Assembly for an Electrical Box

(76) Inventor: James Goings, Toledo, OH (US)

(21) Appl. No.: 13/254,670

(22) PCT Filed: Mar. 5, 2010
(86) PCT No.: PCT/US2010/026334

§ 371 Date: Sep. 2, 2011

Related U.S. Application Data
(60) Provisional application No. 61/157,990, filed on Mar. 6, 2009.

(51) Int. Cl. G08B 7/06

(52) U.S. Cl. 340/657

(57) ABSTRACT

An electrical box assembly for a facility being served with electrical power via a power supply line includes an indicator assembly electrically connected to the power supply line. The indicator assembly indicates whether power is being supplied from the power supply line. The indicator assembly includes a switch and an indicator operable to emit at least one of a visual and audible signal. Actuation of the switch causes operation of the indicator if electrical power is provided in the power supply line.

### CROSS-REFERENCE TO RELATED APPLICATIONS

This application claims the benefit of U.S. Provisional Application No. 61/157,990, filed Mar. 6, 2009.

### BACKGROUND OF THE INVENTION

Electrical power is typically supplied to customers (residences and businesses) by an electrical power company. In a conventional system, electricity is supplied from the power company via primary lines, through one or more transformers, secondary lines, and then via a house drop. The house drop includes power supply lines that eventually connect to a service panel, typically mounted within the residence or business. The service panel includes fuses or circuit breakers for protection of the electrical circuits within the house. Prior to being supplied to a service panel, the power supply lines typically connect to an electric power meter which is used to measure the amount of electrical energy supplied though the power supply lines to the facility. Generally, the power company is responsible for providing and maintaining power to the electrical meter. However, downstream of the meter, the responsibility of providing electrical power to the service panel and the house generally falls to the customer.

Commonly, when an electrical power outage is discovered in a residence or business, the customer calls or otherwise notifies the power company of such problem. The power company may issue a service call and send an employee to check on the power outage. Often times, the customer does not first check the fuses or circuit breakers in their own service panel to determine if these have caused the power interruption. Since the customer is responsible for the electrical circuit downstream of the meter, the customer may get charged for a service call if the power company employee determines that power is in fact being supplied to the meter and the problem is downstream of the meter. Alternatively, the power company may absorb some or all of the service fees. These costs can include an employee's time in answering the customer complaint, an employee's time in driving to the residence and determining the problem causing the outage, use of service trucks, and other associated costs.

### SUMMARY OF THE INVENTION

This invention relates to electrical box assemblies, such as meter box assemblies and service panel assemblies, for a facility being served with electrical power via a power supply line. The electrical box assembly includes an indicator assembly electrically connected to the power supply line. The indicator assembly indicates whether power is being supplied from the power supply line. The indicator assembly includes a switch and an indicator operable to emit at least one of a visual and audible signal. Actuation of the switch causes operation of the indicator if electrical power is provided in the power supply line.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a meter box assembly including an indicator assembly mounted thereon.

FIG. 2 is an enlarged perspective view of the indicator assembly of FIG. 1.

FIG. 3 is a schematic view of the interior of the enclosure of the meter box assembly of FIG. 1 and illustrating the electrical connection of the indicator assembly.

FIG. 4 is a schematic view of an interior of an enclosure of a meter box having an alternate embodiment of an indicator assembly mounted thereon.

FIG. 5 is a schematic view of the interior of an enclosure of a service panel having another alternate embodiment of an indicator assembly mounted thereon.

### DESCRIPTION OF THE EMBODIMENTS

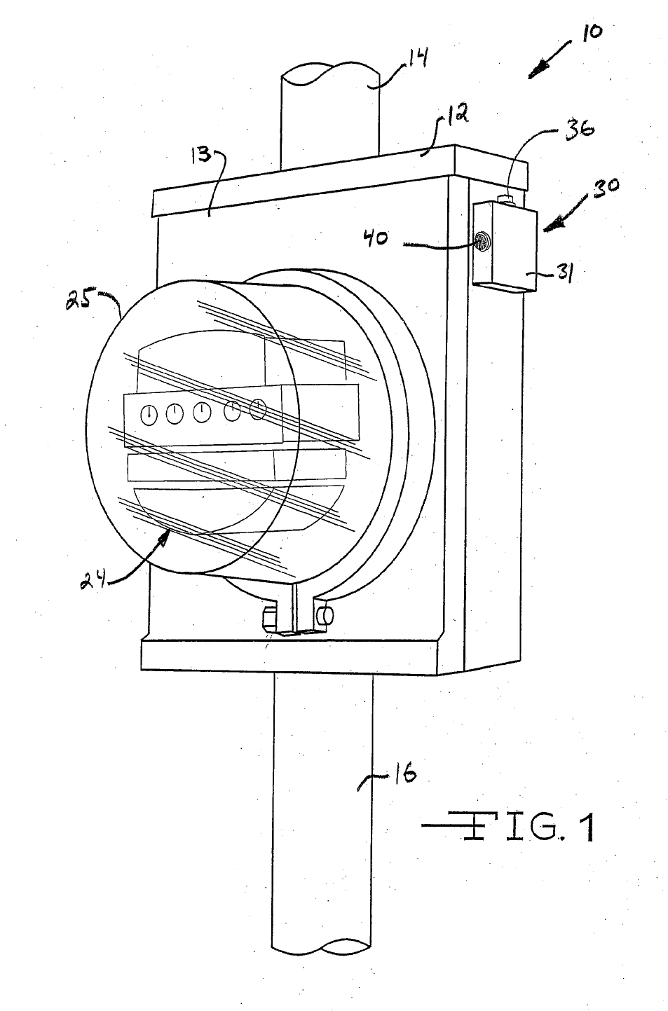

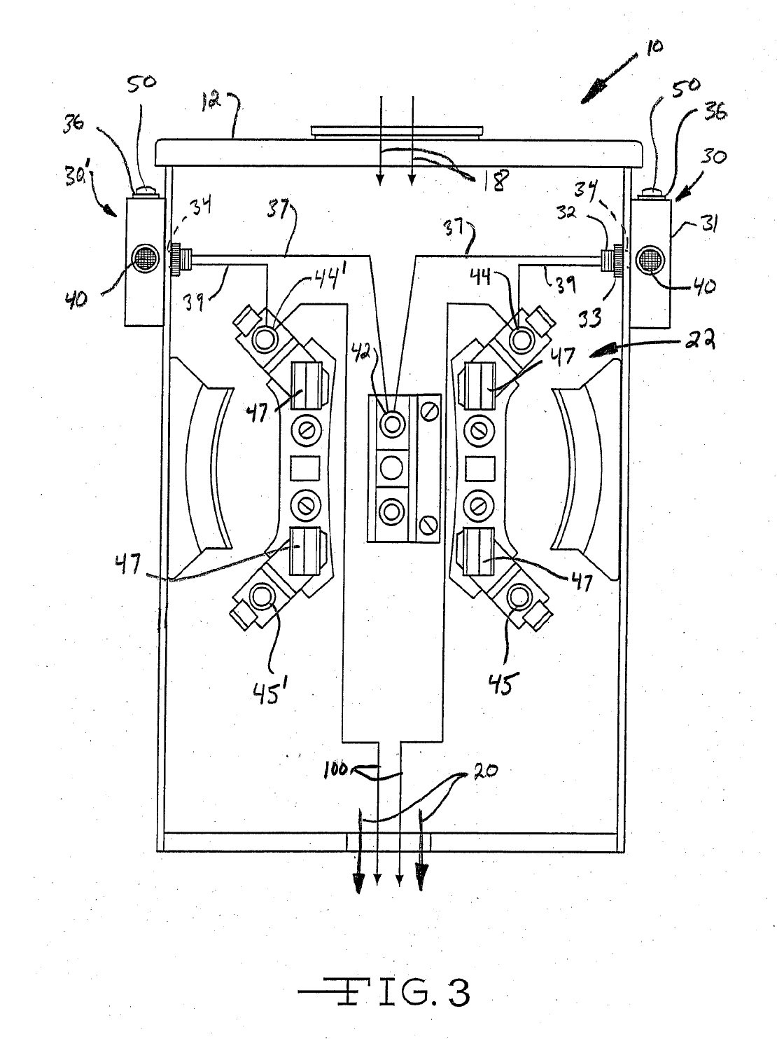

Referring now to the drawings, there is illustrated in FIGS. 1 and 3 an electrical box, or more particular, a meter box assembly, indicated generally at 10. The meter box assembly 10 is typically mounted on an exterior wall of a facility, such as a house or business, which is being supplied with electrical power. The assembly 10 includes an enclosure 12 which may be in the form of a metal or plastic box. The enclosure 12 may include a cover panel 13 to provide access to the interior of the meter box assembly 10. The assembly 10 further includes first and second conduits 14 and 16 attached thereto. One of the conduits 14 includes one of more power supply lines, indicated schematically at 18. The power supply lines 18 may be in the form of electrical wiring that is disposed in the conduit 14 for providing power to the assembly 10 from the power company's primary and secondary lines. The other conduit 16 includes one or more power load lines, indicated schematically at 20. The power load lines 20 may be in the form of electrical wiring that is disposed in the conduit 16 for providing power downstream from the meter box assembly 10 to the facility being served with power. The power load lines 20 may be connected to a service panel assembly within the facility being served with power. The term “line” as used herein can refer to any suitable structure and any number of structures such as wires, cables, or metallic strips than can provide an electrical path therethrough.

As shown in FIG. 3, the assembly 10 includes an electrical socket assembly, schematically indicated at 22. The socket assembly 22 provides for a mechanical and electrical connection to a watt-hour power meter 24. The power meter 24 measures the amount of electricity used by the facility to which it is attached. The power meter 24 may be conventional in nature and may be covered by a transparent cover 25 to permit a visual reading of the meter 24. The socket assembly 22 may have any suitable structure and components that provide for a mechanical and electrical connection for the power meter 24. For example, the socket assembly 22 may include a housing having a plurality of stamped metal circuit paths and attachment clips providing both a mechanical and an electrical connection of the power meter 24. The power supply lines 18 and the power load lines 20 may be connected to the electrical socket assembly 22 and/or to the power meter 24 by any conventional manner. During normal operation, electrical current flows from the power supply lines 18, through the socket assembly 22 and power meter 24, to the power load lines 20. The power meter 24 measures the amount of electricity flowing through the power meter 24 out to the power load lines 20. The meter box assembly 10 may include any number of electrical wires to define power, neutral, ground, data, and communication lines. The meter box assembly 10 can be configured for a single phase system, which is common for residential systems, or a three phase system, which is common for commercial applications. Such systems are well known in the art. Of course, the meter box assembly 10 can be configured for any suitable electrical system.

Additionally, the assembly 10 may further include an optional surge suppressor (not shown). The surge suppressor can include an adapter (not shown) which connects between the power meter 24 and the socket assembly 22 and provides a surge suppression circuit to protect the meter and/or downstream electrical equipment from possible surge damage.

The meter box assembly 10 further includes at least one indicator assembly 30. In the embodiment shown in FIG. 3, the meter box assembly 30 includes a pair of indicator assemblies 30 and 30′. As will be described below, the indicator assemblies 30 provide a simple and convenient way for a user or customer to determine and be notified whether power is being supplied to the meter box 10 from the house drop, thereby possibly avoiding an unneeded service call from the power company. It should be understood that any suitable number of indicator assemblies 30 may be used. Each of the indicator assemblies 30 can be electrically connected to a corresponding power supply line 18. For example, a meter box assembly 10 having two separate power supply lines 18 and power load lines 20 may include an indicator assembly 30 for each of the corresponding lines.

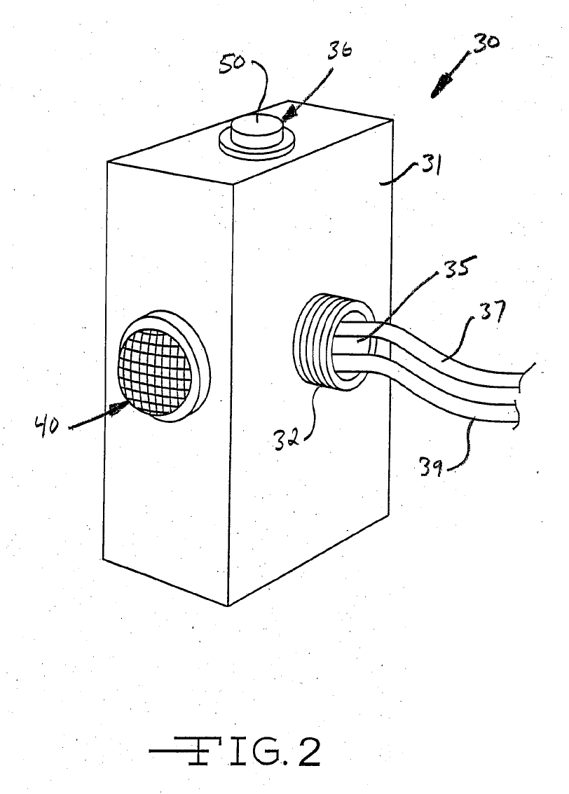

The indicator assembly 30 may be mounted on the meter box assembly 10 or may be integrally formed therewith. In the embodiment show in FIGS. 1 through 3, each of the indicator assemblies 30 includes a box-type housing 31 which is mounted on the enclosure 12. The housings 31 may be mounted on the enclosure 12 by any suitable manner, such as by a hollow threaded bolt 32 and nut 33. The threaded bolts 32 are disposed in openings 34 formed in the enclosure 12. The threaded bolts 32 each have a passageway 35 formed therethrough. The threaded bolts 32 can be integrally formed in the housing 31 or can be separate pieces. To install the housing 31 to the enclosure 12, the threaded bolt 32 is inserted through the opening 34 and the nut 33 is then threadably attached to the bolt 32 to sandwich the enclosure 12 between the housing 31 and the nut 33. If desired, a seal (not shown) can additionally be used to provide a sealed connection. Of course, the housing 31 can be attached by any other suitable manner such as by riveting, welding, or by adhesive. The use of the housing 31 and incorporating the components of the indicator assembly 30 therein provides for a convenient method of installing the indicator assembly 30 to a conventional pre-manufactured enclosure 12. In this manner, the indicator assemblies 30 may be mounted on pre-existing meter box assemblies 10 such that only the openings 34 need be formed in the enclosure 12 prior to installation.

The indicator assembly 30 has an electrical circuit including a switch 36 and an indicator 40. The indicator 40 can be a light bulb, a buzzer or speaker, a meter, or any other suitable indicator device that can provide a visual and/or audible signal when the switch 36 is actuated and electrical power is provided to the power supply lines 18. The switch 36 and the indicator 40 may be electrically connected to the power supply lines 18 by any suitable method such as by direct wiring or by inductive or wireless transmission or sensing. For example, as shown in FIG. 3, the switch 36 and the indicator 40 may be connected via the socket assembly 22. The indicator 40 is electrically connected to a grounded portion 42 of the socket assembly 22 via a wire or line 37. The indicator 40 is also connected to the switch 36. The switch 36 is electrically connected to a hot or powered portion 44 of the socket assembly 22 via a wire or line 39.

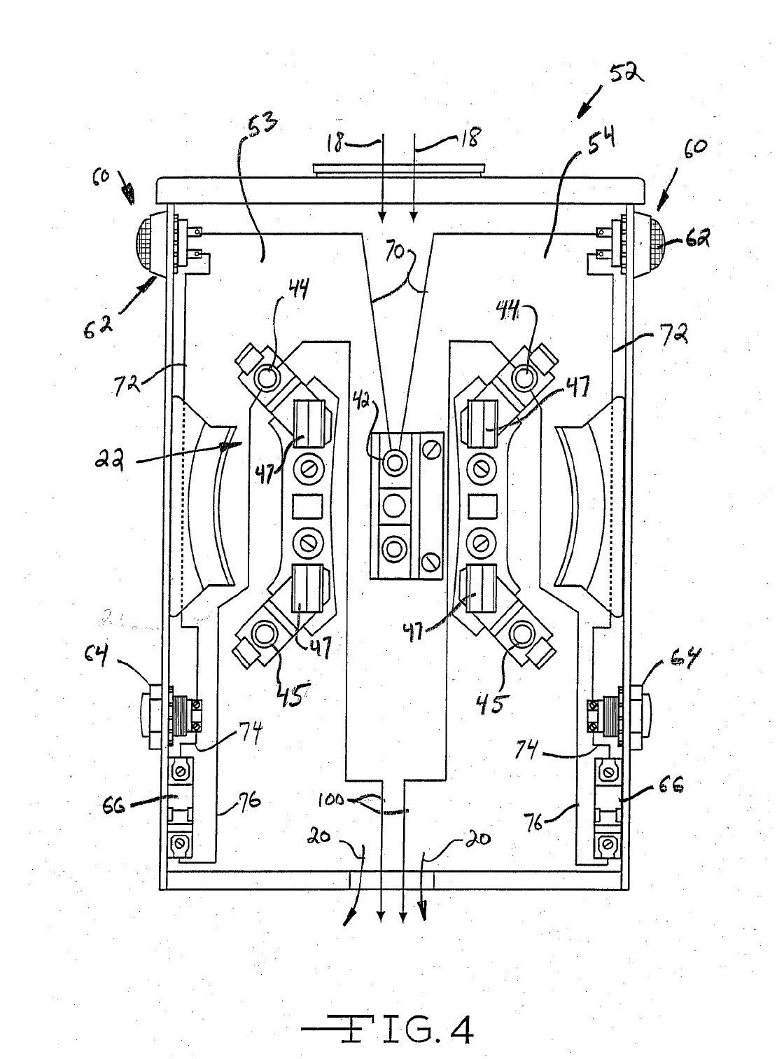

In the socket assembly 22 illustrated in FIG. 3, there are two powered portions 44 and 44′, one for each hot power supply line 18. The socket assembly 22 may also include secondary portions 45 and 45′ which are electrically connected to the hot power load lines 20. The powered portions 44 and 44′ are not directly connected to the powered portions 45 and 45′. For example, the powered portions 44, 44′, 45, 45′ may be formed as metallic portions mounted on an insulated portion of the socket assembly 22. Electricity flows from the hot power supply lines 18 to the hot power load lines 20 via the powered portions 44 and 44′, through the power meter 24, and the powered portions 45 and 45′. Neutral wires of the supply lines 18 and the load lines 20 may be connected to the grounded portion 42 of the socket assembly 22. As shown in the embodiment of the socket assembly 22 illustrated in FIGS. 3 and 4, the socket assembly 22 may include resilient metal clips 47 that provide a releasable mechanical connection as well as an electrical connection for the power meter 24. The power meter 24 may include metal tangs or tabs (not shown) that are frictionally held by the metal clips 47.

The indicator assembly 30 may further include a fuse (not shown) to provide protection of the circuit of the indicator assembly 30 from a fault, such as from a malfunctioning switch 36 or indicator 40. The switch 36 is preferably a manually operated normally open switch such that electrical communication is prevented from flowing in the electrical circuit of the indicator assembly 30 until the switch 36 is actuated.

The operation of the assembly 10 will now be discussed. When the customer wishes to know if power is being supplied to the meter, such as during a possible power outage, the customer actuates the switch 36. Actuation of the switch 36 completes the circuit of the indicator assembly 30 and turns on or actuates the indicator 40. If power is in fact supplied via the power supply lines 18, the indicator 40 will be operated to an “on” position, thereby indicating to the customer that power is being supplied to the meter box assembly 10. Thus, if power goes out in a customer's residence or business, the customer need only actuate the indicator assembly 30 to determine if they need to contact the power company. Alternatively, if a customer calls the power company informing them about a loss of power, the power company can request that the customer operate the indicator assembly 30 during the phone call and let them know whether the indicator was actuated so as to possibly avoid an unneeded service stop at the facility by the power company. If the indicator 40 turns on, the power company can then suggest to the customer to check the fuses or circuit breakers on their service panel and/or call an electrician.

An example of a suitable indicator 40 includes a light (incandescent, LED, fluorescent, etc.) that can be lit up when the indicator is on. Alternatively, the indicator 40 can be a buzzer or speaker which emits a sound when the indicator is on. The indicator 40 may also be a meter such that the user can visually see if the electrical power is in a desired range.

The switch 36 can be any suitable mechanism for completing the electrical path though the indicator assembly 30. For example, the switch 36 may include a manually operated button 50 which causes completion of the electrical circuit. Alternatively, the switch 36 may actuated electrically or electro-mechanically, such as by a solenoid. By utilizing a switch 36 that only activates the indicator 40 when the switch 36 is operated, the life span of the indicator 40 may be increased. For example, if the indicator 40 was a light bulb that was always on, i.e., there is no switch 36 to complete the electrical path, a broken or failed bulb that is not lit may be mistaken for an indication that there is no power being supplied to the meter box 10. However, it should be understood that the indicator assembly 30 may not necessarily include a switch such that an indicator 40 is actuated or turned on when the power is being supplied to the meter box 10. Such an embodiment might use indicators having a relatively long life or may include multiple indicators 40 for redundancy.

Although the assembly 10 is shown having a pair of indicator assemblies 30, it should be understood that a single housing 31 may be used to house both indicator assemblies 30, thus the housing 31 may include two switches 36 and two indicators 40. Alternatively, the housing 31 may include a single switch 36 connected to both circuits with two separate indicators 40. In yet another alternative embodiment, a single switch and single indicator can be connected to both power lines such that if either of the lines does not have power, the indicator will indicate such.

Although the switch 36 and indicator 40 are shown mounted in a housing on a side of the enclosure 12, it should be understood that they can be mounted at any suitable location within or outside of the enclosure 12. For example, the switch 36 and/or indicator 40 could be mounted on the meter 24, the cover 25, or the surge suppressor adapter (not shown). Alternatively, the switch 36 and/or indicator 40 may be mounted at other locations other than the enclosure 12. Since the meter assembly 10 is commonly located outdoors, it may be more convenient to mount the indicator assemblies 30 on the service panel assembly or some other location within the facility being serviced. Since it is unlikely that a short will develop between the meter assembly 10 and service panel, the indicator assemblies 30 will generally provide an accurate indication if power is being supplied upstream of the meter assembly 10 (which is generally the responsibility of the power company).

There is illustrated in FIG. 4 an alternate embodiment of a meter box assembly, indicated generally at 52. The meter box assembly 52 includes a pair of indicator assemblies, indicated generally at 60. Each of the indicator assemblies 60 includes an indicator 62 which may be located remotely from a switch 64. The indicator assembly 60 does not include a separate housing but instead is mounted in an interior 53 of an enclosure 54 of the meter box assembly 52. The electrical connection of the indicator 62 and switch 64 is similar to the embodiments shown and described with respect to FIGS. 1-3. Although two indicator assemblies 60 are shown mounted on either side of the enclosure 12, only one will be described in detail since the other indicator assembly 60 includes similar components and is connected in a similar manner. The indicator assembly 60 generally includes the switch 64, a fuse 66, and the indicator 62. The indicator 62 can be a light bulb, a buzzer or speaker, a meter, or any other suitable indicating device. The indicator 62 is electrically connected to the grounded portion 42 of the socket assembly 22 via a wire or line 70. The indicator 62 is also connected to the switch 64 via a wire or line 72. The switch 64 is electrically connected to the fuse 66 via a wire or line 74. The fuse 66 is connected to the hot portion 44 of the socket assembly 22 via a wire or line 76. The fuse 66 generally protects the circuit from a fault, such as from a malfunctioning switch 64 or indicator 62. The switch 64 may be a normally open switch such that electrical communication is normally prevented from flowing between the lines 72 and 74. When the switch 64 is actuated, the electrical path or circuit between the lines 72 and 74 is completed, thereby enabling actuation of the indicator 62. The indicator assembly 60 operates in a similar manner as the indicator assembly 30 described above such that the user operates the switch 64 to determine if power is supplied to the meter box assembly 52. The indicator 52 and the switch 64 may be mounted through openings formed in the enclosure 54 so that they are accessible from outside the enclosure 54.

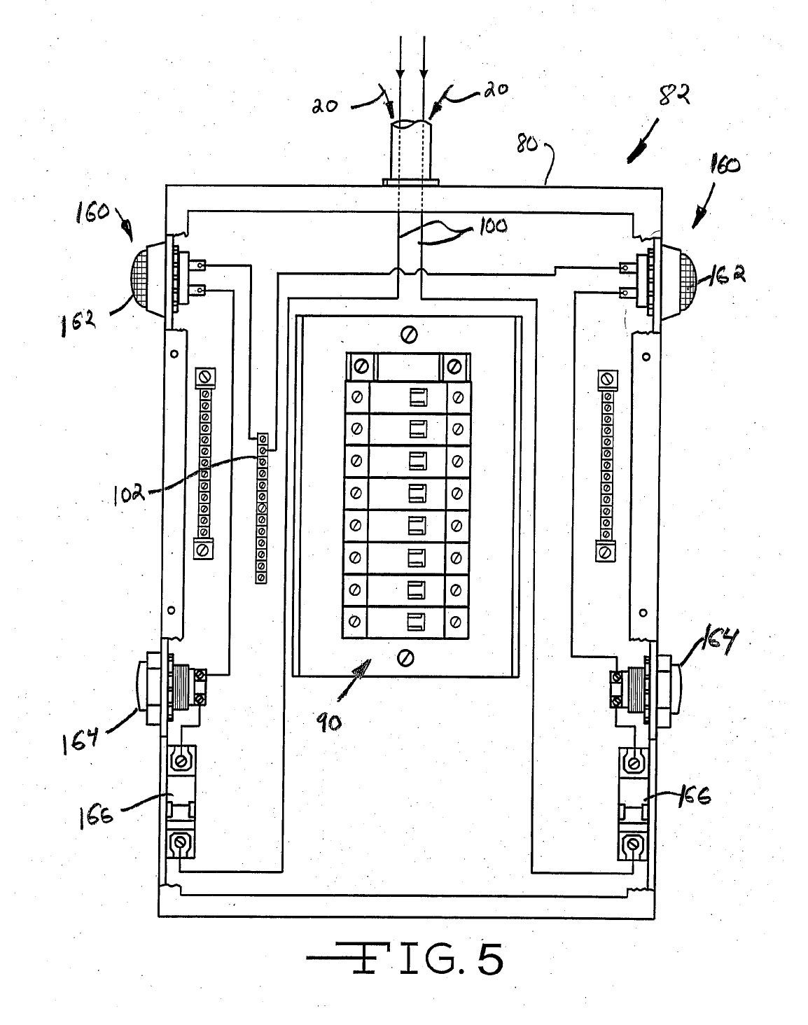

There is illustrated in FIG. 5, an electrical box, or more particular, a service panel assembly 82 which may be used in cooperation with either of the embodiments of the meter box assemblies 10 and 52 described above. The service panel assembly 82 can include various conventionally known circuit breakers 90 and/or fuses which are connected to electrical wiring (not shown) for the facility. Although not shown, the circuit breakers 90 are also connected to power load lines 20 providing power from the house drop to the service panel assembly 82.

The service panel assembly 82 includes indicator assemblies 160 which are similar in structure and function as the indicator assembly 60 of FIG. 4. Each of the indicator assemblies 160 includes an indicator 162, a switch 164, and a fuse 166. One or more interconnection wires or lines 100 can be used to electrically connect the hot portion(s) 44 of the socket assemblies 22 of FIGS. 3 and 4 to the fuses 166. The interconnection lines 100 function in a similar manner as the lines 76 of the meter box assembly 52 of FIG. 4. The indicator assemblies 160 can be electrically connected in a similar manner with respect to the indicator assemblies 60 described above with one end of the circuit being connected to the hot portion 44 of the socket assembly 22 via the line 100 and the other end of the circuit being connected to ground portions 102 of the service panel assembly 82.

The indicator assembly 160 can be used in cooperation with the indicator assemblies 30 and 60 such that any of the indicator assemblies may be actuated to determine if power is provided to the facility. Thus, the consumer can use whichever one is convenient. However, it should be understood that the facility may include a service panel assembly 82 having an indicator assembly 160 and a conventional meter box assembly not including an indicator assembly. The service panel assembly 82 may also be provided with one or more indicator assemblies resembling the indicator assemblies 30 described above such that they are mounted within their own housings and are attached to the service panel assembly 82.

Although the indicator assemblies 30, 60, and 160 are shown mounted in the enclosures of the respective meter box assemblies and service panel assemblies, the indicators and/or switches may be mounted elsewhere. For example, if the service panel is mounted in the basement or garage of the facility, the indicator and/or switch may be mounted next to an entrance door or some other convenient location within the facility. Alternatively, an additional remote indicator assembly (not shown) may be connected to the indicator assembly such that either one can be operated to determine if power is being supplied to facility.

As used herein, the term electrical box assembly refers to either a meter box assembly or a service panel assembly such that power supply lines are directed into the box and power load lines are directed out of the box. The power supply lines are directly or indirectly connected to a source of electrical power such as from primary lines, transformers, secondary lines, and house drops from an electrical power company that supplies electrical power to the facility. The power load lines are connected to various electrical circuits of the facility to provide electrical to electrical outlets within the facility. In the case of a meter box assembly, the meter of the meter box assembly is connected between the power supply lines and the power load lines for measuring the amount of electrical energy being supplied to the facility. In the case of a service panel assembly, the circuit breakers and/or fuses are connected between the power supply lines to provide protection in case of a fault.

The principle and mode of operation of this invention have been explained and illustrated in its preferred embodiments. However, it must be understood that this invention may be practiced otherwise than as specifically explained and illustrated without departing from its spirit or scope.

What is claimed is:

1. An electrical box assembly for a facility being served with electrical power via a power supply line, said electrical box assembly comprising:
an indicator assembly adapted to electrically connect to the power supply line for indicating whether power is being supplied from said power supply line, said indicator assembly including:
a switch; and
an indicator operable to emit at least one of a visual and audible signal, wherein actuation of said switch causes operation of said indicator if electrical power is provided in said power supply line.

2. The assembly of claim 1, wherein said electrical box assembly includes an enclosure, and wherein said indicator assembly is mounted on the exterior of said enclosure.

3. The assembly of claim 2, wherein said switch and said indicator are disposed in a housing which is mounted on said enclosure.

4. The assembly of claim 3, wherein said enclosure and said housing include openings formed therein to provide for the passage of wiring between said enclosure and said housing.

5. The assembly of claim 1, wherein said electrical box assembly includes an enclosure, and wherein said indicator assembly is mounted in an interior of said enclosure.

6. The assembly of claim 5, wherein said switch and said indicator are mounted within openings of said enclosure such that said switch and said indicator are accessible from outside said enclosure.

7. The assembly of claim 1, wherein said indicator assembly further includes a fuse.

8. The assembly of claim 1, wherein said switch is a manually operated normally open switch.

9. The assembly of claim 1, wherein said indicator includes a bulb for emitting a light indicating that power is being supplied from said power supply line.

10. The assembly of claim 1, wherein said indicator is a speaker for emitting a sound indicting that power is being supplied from said power supply line.

11. The assembly of claim 1, wherein said electrical box assembly defines a meter box assembly including a power meter electrically connected to the power supply line for measuring the amount of electricity used by the facility via the power supply line.

12. The assembly of claim 11, wherein said electrical box assembly further includes a socket assembly for mounting said power meter to said electrical box assembly, and wherein said socket assembly includes powered and grounded portions that route electrical power from the power supply line to said power meter.

13. The assembly of claim 12, wherein said indicator assembly is electrically connected to said powered and grounded portions of said socket assembly to provide an electrical connection to said switch and said indicator.

14. The assembly of claim 1, wherein said electrical box assembly defines a service panel assembly including a plurality of circuit breakers therein connected to said power supply line and a power load line providing electrical power downstream of the electrical box assembly to the facility.

15. The assembly of claim 1 including first and second power supply lines providing electrical power, and wherein said assembly further includes first and second indicator assemblies connected to the first and second power supply lines, respectively.

16. A meter box assembly for a facility being served with electrical power via a power supply line, said meter box assembly comprising:
an enclosure;
a power meter adapted to be electrically connected to the power supply line and a power load line for measuring the amount of electricity used by the facility;
an indicator assembly adapted to be electrically connected to the power supply line for indicating whether power is being supplied from the power supply line, said indicator assembly including:
a manually operated normally open switch;
a fuse; and
an indicator operable to emit at least one of a visual and audible signal, wherein actuation of said switch causes operation of said indicator if electrical power is provided in said power supply line.

17. The assembly of claim 16, wherein said electrical box assembly further includes a socket assembly for mounting said power meter to said electrical box assembly, and wherein said socket assembly includes powered and grounded portions that route electrical power from the power supply line to said power meter, and wherein said indicator assembly is electrically connected to said powered and grounded portions of said socket assembly to provide an electrical connection to said switch and said indicator.

18. The assembly of claim 16 including first and second power supply lines providing electrical power, and wherein said assembly further includes first and second indicator assemblies connected to the first and second power supply lines, respectively.
